(19) United States
(12) Patent Application Publication
(10) Pub. No.: US 2011/0214576 A1
(43) Pub. Date: Sep. 8, 2011

(54) STEPLESS HEIGHT ADJUSTING MECHANISM OF THE LEVER ON GRILLING PAN

(75) Inventor: Xinzhu Li, Zhangzhou (CN)

(73) Assignee: TSANN KUEN (ZHANGZHOU) ENTERPRISE CO., LTD., Fujian (CN)

(21) Appl. No.: 13/128,421

(22) PCT Filed: Nov. 12, 2009
(86) PCT No.: PCT/CN2009/074912

§ 371 Date: May 10, 2011

(30) Foreign Application Priority Data
Nov. 13, 2008 (CN) 200820146372.5

(51) Int. Cl. A47J 37/06

(52) U.S. Cl. 99/379

(57) ABSTRACT

A stepless height adjusting mechanism of a grilling pan lever, has a lever, a lifting pin, a cam and a knob. The cam is a disk-shaped element with a gradually increasing diameter and rotates around a fixed shaft disposed on the rear portion of the side of the lower housing, the inside of the articulated portion of the lever is fixed with a skew surface wall, the distance between the skew surface wall and the articulated shaft of the rear portion of the lower grilling pan increases gradually, the lifting pin is disposed between the cam and the skew surface wall, and moves vertically between the cam and the skew surface wall, and leaned against the outer peripheral surface of the cam and the skew surface wall; the outside of the cam is fixed with the knob. The mechanism realizes stepless height adjustment of the lever from 0° to 45°.

### FIELD OF THE INVENTION

The present invention relates to the food processing device, especially relates to a stepless adjusting mechanism of the lever on grilling pan adaptable for grilling sandwich or hamburger.

### BACKGROUND OF THE INVENTION

The grilled Italian sandwich (panini) or hamburger are the common western food, the grilling pan for grilling sandwich or hamburger usually comprises an upper grilling pan and a lower grilling pan articulated with the upper grilling pan, the sandwich or hamburger is sandwiched between the upper and lower grilling pan when it is grilled, this kind of grilling pan has a H-shaped lever which is fixed to the upper grilling pan, and the upper grilling pan is articulated on the lower grilling pan with said H-shaped lever, in the grilling state, when the included angle between said H-shaped lever and the horizontal line is smaller than 90°, the upper grilling pan will be kept on the horizontal position throughout. When this kind of grilling pan is being used, it needs to lift the lever with a certain height manually, so the sandwich or the hamburger can be put inside the grilling pan, then put down the lever and clamp the upper and lower grilling pans tightly, this kind of grilling pan can not position the lever and the upper grilling pan on a certain height, thereby the stepless height adjustment of the lever can not be realized.

### SUMMARY OF THE INVENTION

The main object of the present invention is to overcome the shortages of the grilling pan of the conventional technique which can not fix the position of the stepless height of the lever, and to provide a stepless adjusting mechanism of the lever on grilling pan.

The technical solution applied by the present invention is: a stepless height adjusting mechanism of the lever on grilling pan, said grilling pan has an upper grilling pan and a lower grilling pan, said stepless height adjusting mechanism comprises a lever, said lever is articulated with an articulated shaft of the rear portion on the lower grilling pan with an articulated portion and fixed to the upper grilling pan; said stepless height adjusting mechanism further comprises a lifting pin, a cam and a knob; a terminal of said lifting pin is leaned against the cam, another terminal of which is leaned against the articulated portion of the lever; the cam is connected to the knob, the rotation of the knob drives the cam rotate, the rotation of the cam push the lifting pin move up and down, so the stepless height adjustment of the lever is realized.

Said cam is disk-shaped element with a gradually increasing diameter and rotates around a fixed shaft disposed on the rear portion of the side of the lower housing, the inside of the articulated portion of said lever is fixed with a skew surface wall, the distance between said skew surface wall and the articulated shaft of the rear portion of the lower grilling pan increases gradually, said lifting pin is disposed between the cam and the skew surface wall, moves up and down between them and leaned against the outer peripheral surface of the cam and the skew surface wall; the outside of said cam is fixed with said knob.

Said lifting pin is disposed in a pin bush, said lifting pin moves up and down in said pin bush with zero clearance.

The articulated portion of said lever has a sliding groove, said lifting pin is leaned against between said cam and skew surface wall after passing through said sliding groove.

Said lifting pin is leaned against the outer peripheral surface of the cam throughout.

The outside of said cam has two protruding ribs, the center of said knob has two grooves, the knob is fixed to the cam by the cooperation of said grooves and the ribs.

The included angle between said lever and the lower grilling pan is ranged from 0° to 45°.

When the stepless height adjusting mechanism of the lever on grilling pan of the present invention is used, firstly rotate the knob to drive the cam rotate, because the diameter of the cam increases gradually, so the cam will push the lifting pin mover upward, the lifting pin will act on the skew surface wall inside of the articulated portion of the lever, so the lever can be lifted; when it needs to put down the lever, it only needs to rotate the knob with the opposite direction, it is convenient for adjusting the height of the lever, thereby the stepless height adjustment of the lever is realized.

Concluded from the description of the present invention and compared to the conventional technique, the stepless height adjusting mechanism of the lever on grilling pan of the present invention realizes the stepless height adjustment by the cooperation of the lever, the lifting pin, the cam and the knob, the assembly is convenient, the structure is simple and reliable.

### BRIEF DESCRIPTION OF THE DRAWINGS

FIG. 1 is the perspective structural view of the present invention;

FIG. 2 is the structural view of the closed grilling pan of the present invention;

FIG. 3 is the structural view of the lever of the present invention when the lever is lifted up with 5°;

FIG. 4 is the structural view of the lever of the present invention when the lever is lifted up with 20°;

FIG. 5 is the structural view of the lever of the present invention when the lever is lifted up with 45°.

### DETAILED DESCRIPTION OF THE EMBODIMENTS

The present invention will become apparent with the reference of the preferred embodiment.

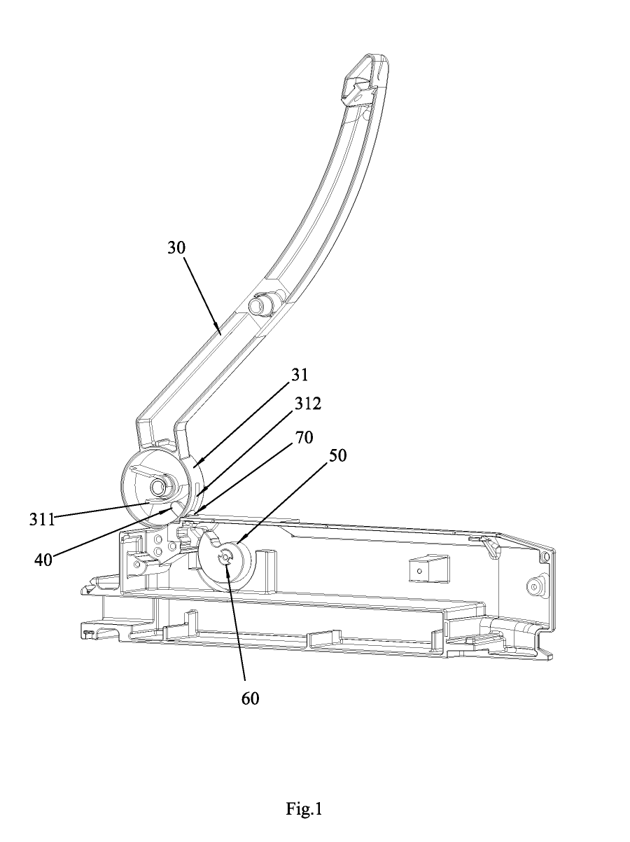

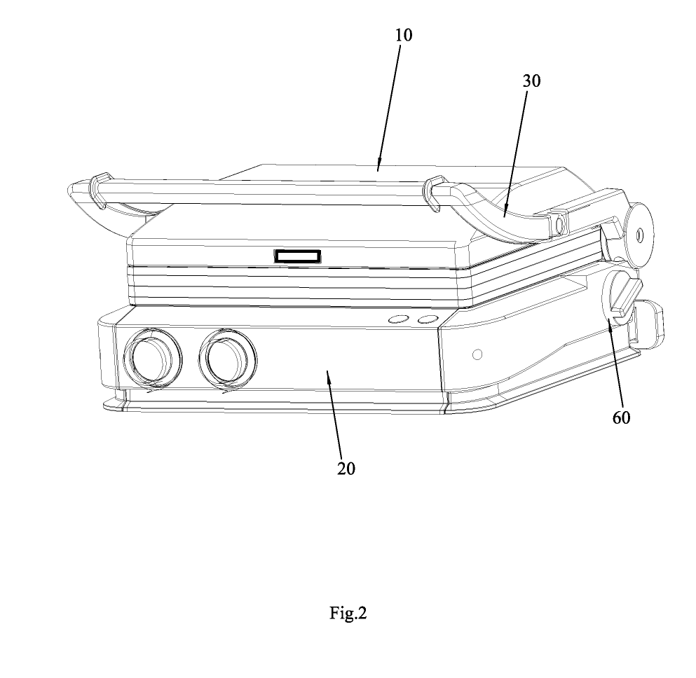

Please refer to FIG. 1 to FIG. 5, the stepless height adjusting mechanism of the lever on grilling pan of the present invention, said grilling pan has an upper grilling pan 10 and a lower grilling pan 20, said stepless height adjusting mechanism comprises a lever 30, said lever 30 is articulated on a articulated shaft 21 of the rear portion of the lower grilling pan 20 with an articulated portion 31 and is fixed to the upper grilling pan 10; said stepless height adjusting mechanism further comprises a lifting pin 40, a cam 50 and a knob 60.

Said cam is a disk-shaped element with a gradually increasing diameter and rotates around a fixed shaft and disposed on the rear portion of the side of the lower housing; the outside of the cam 50 has two protruding ribs, the center of the knob 60 has two grooves, the knob 60 is fixed to the cam 50 by the cooperation of said grooves and the ribs.

The inside of the articulated portion 31 of the lever 30 is fixed with a skew surface wall 311, the distance between said skew surface wall 311 and the articulated shaft 21 of the rear portion of the lower grilling pan increases gradually; the profile curve of the cam 50 is adapted to the curve of the curve of the skew surface wall 311.

The lifting pin 40 is a flat strip, the two terminals of the lifting pin 40 along its lengthwise direction are circular arc shape, the lifting pin 40 is disposed between the cam 50 and the skew surface wall 311 and moves up and down between them, further the two terminals are respectively leaned against the outer peripheral surface of the cam 50 and the skew surface wall 311;

The pin bush 70 is fixed to the lower housing, the pin shaft 40 moves up and down in said pin bush 70 with zero clearance, so the pin shaft 40 is ensured to only move between the outer peripheral wall of the cam 50 and the skew surface wall 311 and can not sway, so the position of the lever 30 is fixed reliably in the stepless height adjustment, it can be prevented from sway and unsteady.

The circumferential surface of the articulated portion 31 of the lever 30 has a sliding groove 312, the lifting pin 40 is leaned against between the cam 50 and the skew surface wall 311 after passing through said sliding groove 312. The lifting pin 40 is leaned against the outer peripheral surface of the cam 50 throughout. It only needs to rotate the knob 60, then the lifting pin 40 can move up and down in the pin bush 70.

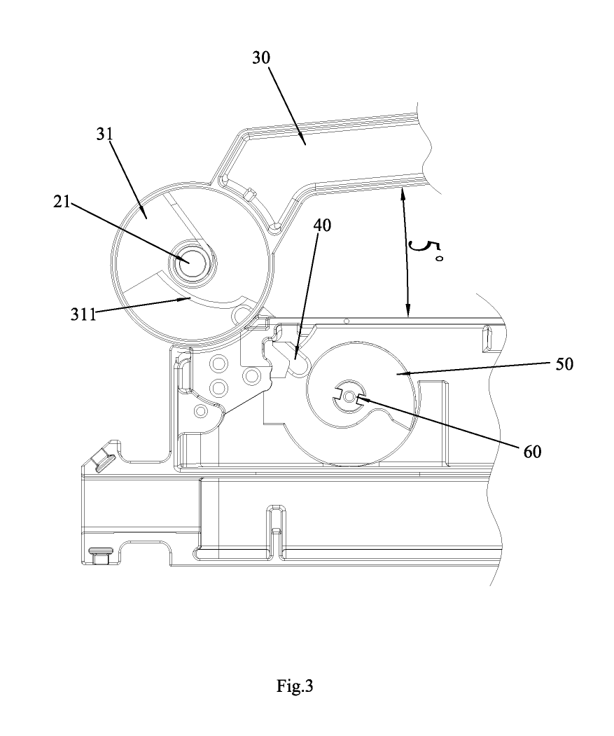

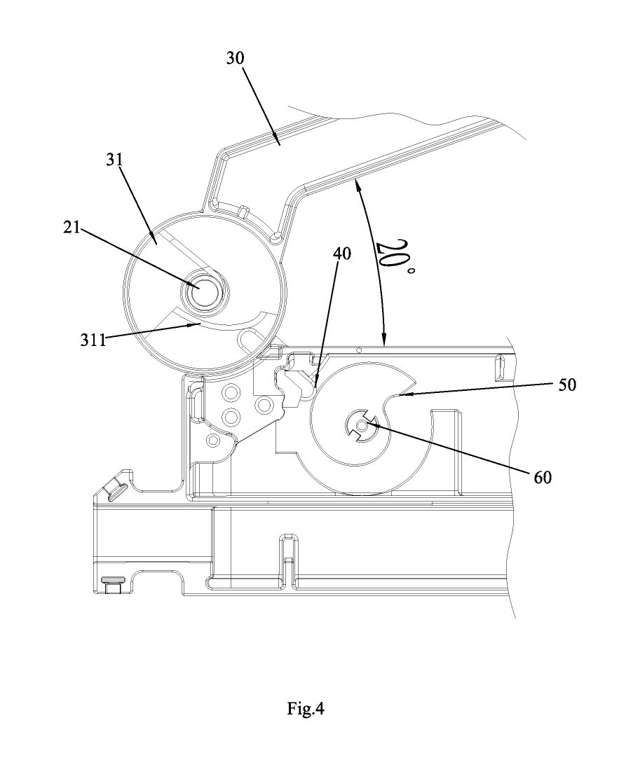

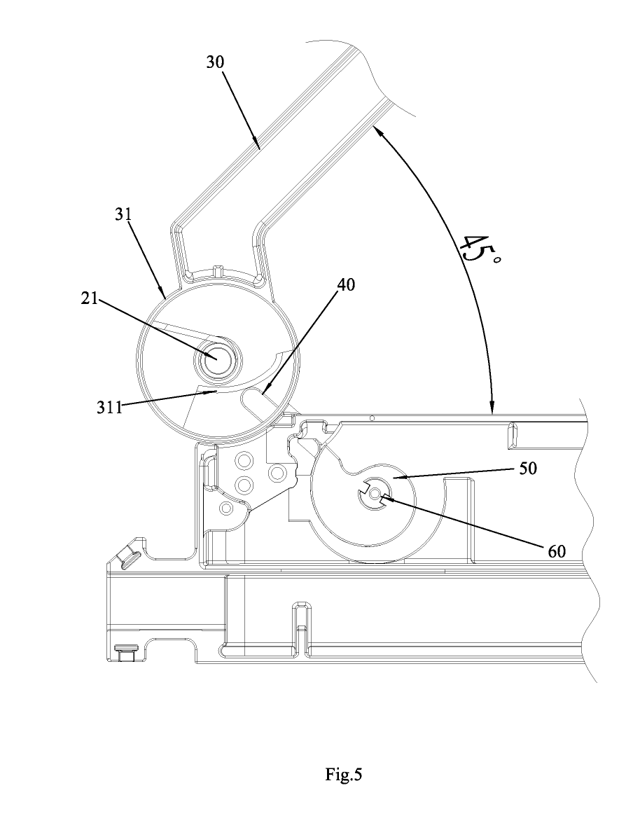

The present invention realizes the stepless height adjustment of the lever from 0° to 45° by the cooperation of the lever 30, the lifting pin 40, the cam 50 and the knob 60, please refer to FIG. 3, the lifting angle of the lever 30 is 5°, at this time the rotational angle of the knob 60 is relatively small, the lifting pin 40 is leaned against a relatively low position with the cam 50 and acts on the front end of the skew surface wall 311 of the lever 30; please refer to FIG. 4, at this time the lever 30 is lifted up with 20°, the lifting pin 40 is leaned against the middle portion of the skew surface wall 311 of the lever 30; please refer to FIG. 5, at this time the rotational angle of the knob is relatively large, the lifting pin 40 is leaned against a relatively high position with the cam 50 and acts on the rear portion of the skew surface wall 311 of the lever 30.

Although the present invention has been described with reference to the preferred embodiments thereof for carrying out the invention, it is apparent to those skilled in the art that a variety of modifications and changes may be made without departing from the scope of the present invention which is intended to be defined by the appended claims.

### INDUSTRIAL APPLICABILITY

The stepless height adjusting mechanism of the lever on grilling pan of the present invention, it realizes the stepless height adjustment of the lever from 0° to 45° by the cooperation of the lever, the lifting pin, the cam and the knob, the assembly is convenient, the structure is simple and reliable, it has a good industrial applicability.

What is claimed is:

1. A stepless height adjusting mechanism of the lever on grilling pan, said grilling pan has an upper grilling pan and a lower grilling pan, said stepless height adjusting mechanism comprises a lever, said lever is articulated with an articulated shaft of the rear portion on the lower grilling pan with an articulated portion and fixed to the upper grilling pan; wherein said stepless height adjusting mechanism further comprises a lifting pin, a cam and a knob; said cam is disk-shaped element with a gradually increasing diameter and rotates around a fixed shaft disposed on the rear portion of the side of the lower housing, the inside of the articulated portion of said lever is fixed with a skew surface wall, the distance between said skew surface wall and the articulated shaft of the rear portion of the lower grilling pan increases gradually, said lifting pin is disposed between the cam and the skew surface wall, moves up and down between them and leaned against the outer peripheral surface of the cam and the skew surface wall, the rotation of the knob drives the cam rotate, the rotation of the cam push the lifting pin move up and down, so the stepless height adjustment of the lever is realized.

2. The stepless height adjusting mechanism of the lever on grilling pan according to claim 1, wherein said lifting pin is disposed in a pin bush, said lifting pin moves up and down in said pin bush with zero clearance.

3. The stepless height adjusting mechanism of the lever on grilling pan according to claim 1, wherein the circumferential surface of the articulated portion of said lever has a sliding groove, said lifting pin is leaned against between said cam and skew surface wall after passing through said sliding groove.

4. The stepless height adjusting mechanism of the lever on grilling pan according to claim 1, wherein said lifting pin is leaned against the outer peripheral surface of the cam throughout.

5. The stepless height adjusting mechanism of the lever on grilling pan according to claim 1, wherein the outside of said cam has two protruding ribs, the center of said knob has two grooves, the knob is fixed to the cam by the cooperation of said grooves and the ribs.

6. The stepless height adjusting mechanism of the lever on grilling pan according to claim 1, wherein said lifting pin a flat strip, the two terminals along the lengthwise direction of said lifting pin are circular arc shape.

7. The stepless height adjusting mechanism of the lever on grilling pan according to claim 1, wherein the profile curve of said cam is adapted to the curve of the skew surface wall.
